(19) United States
(12) Patent Application Publication
(10) Pub. No.: US 2023/0153692 A1
(43) Pub. Date: May 18, 2023

(54) CONTINUAL LEARNING IN DYNAMIC COMMUNICATION SYSTEMS

(71) Applicants: Regents of the University of Minnesota, Minneapolis, MN (US); Oregon State University, Corvallis, OR (US)

(72) Inventors: Mingyi Hong, Wayzata, MN (US); Haoran Sun, Bellevue, WA (US); Xiao Fu, Albany, OR (US)

(21) Appl. No.: 18/054,479

(22) Filed: Nov. 10, 2022

Related U.S. Application Data
(60) Provisional application No. 63/263,967, filed on Nov. 12, 2021.

(51) Int. Cl. G06N 20/00

(52) U.S. Cl. CPC G06N 20/00

(57) ABSTRACT

A wireless communication system includes memory configured to store a model for predicting one or more parameters of the system, and one or more processors configured to: receive samples of the wireless communication system over a plurality of sequential batches, each of the batches represents a different, non-overlapping period of time; for each of the batches: select, based on a sample selection criteria, a subset of the samples from a first batch as representative samples for the first batch, wherein the sample selection criteria is based on a system performance metric computed for each of the samples; store the subset of the samples for one or more of the sequential batches in the memory; and upon receiving samples for a second batch, train the model to predict the one or more parameters using the samples from the second batch and the subset of the samples stored in the memory.

This application claims the benefit of U.S. Provisional Patent Application 63/263,967, filed Nov. 12, 2021, the entire content of which is incorporated by reference.

### GOVERNMENT RIGHTS

This invention was made with government support under CNS-2003033 and CNS-2003082 awarded by the National Science Foundation. The government has certain rights in the invention.

### TECHNICAL FIELD

The disclosure relates to wireless communication networks including, for example, acquiring state information for wireless communication networks.

### BACKGROUND

There has been a growing interest in developing data-driven and in particular deep neural network (DNN) based methods and systems for modern communication networks. For a few popular problems such as power control, beamforming, and MIMO detection, these methods and systems achieve state-of-the-art performance while requiring less computational effort, fewer resources for acquiring channel state information (CSI), etc.

### SUMMARY

This disclosure describes new data-driven methods and systems to continuously learn and optimize wireless communication strategies in a dynamic environment (e.g., the statistical distribution of some samples characterizing the environment is time-varying). Communication systems are described which utilizes the technique of continual learning (CL) so that the learning model can incrementally adapt to the new environment distributions, without forgetting knowledge learned from the previous environment distributions. In some examples, the systems are based on a bilevel optimization formulation that ensures certain “fairness” across different data samples.

The data-driven techniques for continuously learning and optimizing resource allocation strategies described herein provide significant technical advantages, including in “episodically dynamic” settings where the environment statistics change in “episodes”, and in each episode the environment is stationary. Described are example systems configured to perform continual learning (CL) of underlying machine learning models, so that the learning models can incrementally adapt to new episodes without forgetting knowledge learned from previous episodes. In some examples, the CL systems are based on a bilevel optimization formulation which ensures certain “fairness” across different data samples. This disclosure demonstrates the effectiveness of the example CL approaches by, as examples, integrating the approach with deep neural network (DNN)-based models (e.g., for power control and beamforming), respectively, and testing using both synthetic and ray-tracing based data sets. These numerical results show that the example CL approaches is not only able to adapt to the new scenarios quickly and seamlessly, but importantly, it also maintains high performance over the previously encountered scenarios as well.

In one example, the disclosure describes a wireless communication system comprising: memory configured to store a model for predicting one or more parameters of the wireless communication system; and one or more hardware-based processors configured to: receive samples of the wireless communication system over a plurality of sequential batches, wherein each of the batches represents a different, non-overlapping period of time; for each of the batches: select, based on a sample selection criteria, a subset of the samples from a first batch of the plurality of batches as representative samples for the first batch, wherein the sample selection criteria is based on a system performance metric computed for each of the samples; store the subset of the samples for one or more of the plurality of sequential batches in the memory; and upon receiving samples for a second batch, train the model to predict the one or more parameters using the samples from the second batch and the subset of the samples stored in the memory.

In one example, the disclosure describes a method for predicting one or more parameters of a wireless communication system: receiving samples of the wireless communication system over a plurality of sequential batches, wherein each of the batches represents a different, non-overlapping period of time; for each of the batches: selecting, based on a sample selection criteria, a subset of the samples from a first batch of the plurality of batches as representative samples for the first batch, wherein the sample selection criteria is based on a system performance metric computed for each of the samples; storing the subset of the samples for one or more of the plurality of sequential batches in a memory; and upon receiving samples for a second batch, training the model to predict the one or more parameters using the samples from the second batch and the subset of the data samples stored in the memory.

In one example, the disclosure describes a computer-readable storage medium comprising instructions for causing a programmable processor to: receive samples of a wireless communication system over a plurality of sequential batches, wherein each of the batches represents a different, non-overlapping period of time; for each of the batches: select, based on a sample selection criteria, a subset of the samples from a first batch of the plurality of batches as representative samples for the first batch, wherein the sample selection criteria is based on a system performance metric computed for each of the samples; store the subset of the samples for one or more of the plurality of sequential batches in the memory; and upon receiving samples for a second batch, train the model to predict the one or more parameters using the samples from the second batch and the subset of the samples stored in the memory.

The details of one or more examples are set forth in the accompanying drawings and the description below. Other features, objects, and advantages will be apparent from the description and drawings, and from the claims.

### BRIEF DESCRIPTION OF DRAWINGS

FIGS. 1A and 1B are block diagrams of example wireless communication systems in accordance with one or more examples described in this disclosure.

FIG. 2 is a conceptual diagram of an example wireless communication system configured for continuous learning (CL) in various environments, including episodically dynamic environments.

FIG. 3 is a flowchart illustrating example operation of the wireless communication system according to the techniques described herein.

FIG. 4 is a flowchart illustrating another example operation of the wireless communication system according to the techniques described herein.

FIG. 5 is a flowchart illustrating an example of bilevel optimization for determination of samples to be stored.

### DETAILED DESCRIPTION

This disclosure describes wireless communication systems configured and architected for “learning to continuously optimize” wireless resources in dynamic environments, where parameters such as channel state information (CSI) keep changing. For instance, in wireless communication systems, devices (e.g., phones, computers, and other such devices) connect with respective base stations. The respective base stations, or some other component, may determine respective parameters (e.g., CSI) for the communication link between the devices and the base stations.

This disclosure describes example techniques of using machine learning-based techniques (e.g., such as neural network models) that are configured to determine parameters for communication links in a wireless system utilizing both information of the current wireless system configuration and information of previous wireless system configuration(s). Information of the wireless system may be referred to as samples of the wireless system. Samples of the wireless system may be considered a “snapshot” of the wireless system. For example, a snapshot of the wireless system may include configuration information of the wireless system, such as CSI, a number of devices connected to a base station, locations of the devices, etc., within a relatively short period of time (e.g., within a few seconds of time, within a second of time, or at an instant in time).

It is often challenging to use machine learning-based techniques, such as deep neural network (DNN) based algorithms, when the environment (such as CSI, device location, number of devices, etc.) keeps changing. There may be several reasons for such challenges in using machine learning-based techniques. For instance, naive deep learning (DL) based methods typically suffer from severe performance deterioration when the environment changes, that is, when the real-time data follows a different distribution than those used in the training stage. It may be possible to adopt the transfer learning and/or online learning paradigm, by updating the DNN model according to data generated from the new environment. However, these approaches usually degrade or even overwrite the previously learned models. Therefore, the approaches are sensitive to outlier conditions because once adapted to a transient (outlier) environment/task, its performance on the existing environment/task can degrade significantly. Such kinds of behavior are particularly undesirable for wireless resource allocation tasks, because the unstable model performance would cause large outage probability for communication users. Moreover, if the entire DNN is periodically retrained using all or significant portions of historical data, training can be time and memory consuming since the amount of data needed keeps growing.

Due to these challenges, it is unclear how state-of-the-art DNN based communication algorithms could properly adapt to new environments quickly without experiencing significant performance loss over previously encountered environments. This disclosure provides technical solutions to the challenges discussed above, and describes data-driven neural network models that can adapt to the new environment efficiently (i.e., by using as little resource as possible), seamlessly (i.e., without knowing when the environment has been changed), quickly (i.e., adapt well using only a small amount of data), and/or continually (i.e., without forgetting the previously learned models).

As described in more detail below, in one or more examples, one or more processors may be configured to determine samples in respective batches, where each of the batches represents a different, non-overlapping period of time. In one or more examples, the statistical distribution of some samples of the wireless communication system may change. The length of time per statistical distribution is typically not known. The boundary of the statistical distribution change is typically not known. In this disclosure, each period of statistical distribution may be referred to as one time episode, where during any given time episode, the statistical distribution of some samples of the wireless communication system may not change. However, the boundaries of when the statistical distribution/time episodes of the wireless communication system may change is typically not known, and the length of time per statistical distribution/time episodes is typically not known.

Each time episode can be composed of one or multiple “batches.” In one or more examples, the length of time per “batch” may be known (e.g., preset or otherwise set, e.g. batch can in order of seconds or milliseconds or others). In some examples, during any given “batch,” the statistical distribution of some samples of the wireless communication system might not change.

Each “batch” can be composed of one or multiple snapshots (e.g., samples). Each sample represents the wireless communication system at that single timestamp (e.g., snapshot). In one or more examples, within a time episode (or simply episode), there may be one or more batches. The batches need not align with the time episodes. For example, a batch may traverse two episodes. This may be because the boundary of the episodes (e.g., where the statistical distribution of wireless communication system changes) may be unknown. Also, the length of the time of an episode may change.

At the beginning of a batch, the one or more processors may train a neural network model based on the samples within the batch. As noted above, samples refers to information of the wireless system. For example, the samples of the wireless system may be considered as a “snapshot” of the wireless system. For example, a snapshot of the wireless system may include configuration information (e.g., characteristics or environment information) of the wireless system, such as CSI, a number of devices connected to a base station, a location of the devices, etc., within a relatively short period of time (e.g., within a few seconds of time, within a second of time, or at an instant in time).

After training the neural network model (e.g., after generating the trained neural network model), the one or more processors may apply the neural network model to predict one or more parameters of the wireless communication system. The one or more parameters may be power parameters, beamforming parameters, multicasting parameters, multiuser detection, channel estimation parameters, spectrum sensing parameters, or spectrum/channel/antenna allocation parameters, as a few non-limiting examples. In some examples, the one or more parameters may be an estimate of channel state information for a wireless channel of the wireless communication system.

The one or more processors may be configured to allocate resources within the wireless communication system based on the predicted one or more parameters. As one example, to allocate resources, the one or more hardware-processors are configured to control an allocation of power to a plurality of base stations of the wireless communication system for a given geographic region based on the predicted one or more parameters. As another example, to allocate resources, the one or more hardware-processors are configured to control beamforming for a plurality of antennas of the wireless communication system based on the predicted one or more parameters.

As described above, in some instances, the characteristics of the wireless communication system may change between episodes (e.g., there may be a change in the distribution). For instance, some devices may disconnect, or some new devices may connect. The interference level may increase or decrease, and the like. Therefore, the trained neural network model may not provide a sufficiently adequate prediction of the one or more parameters. Also, the boundary of the episodes (e.g., when the distribution is going to change) may be unknown.

Accordingly, in one or more examples, the one or more processors may train a neural network model over an initial time in each batch. However, relying only on the samples within the current batch may fail to account for the change in the distribution of the wireless communication system being gradual. That is, forgetting samples from previous time episodes or batches may result in a neural network model that does not correctly predict parameters for the wireless communication system. Coincidentally, storing too many samples of previous time episodes or batches for training may result in excessive memory utilization, and increasing the amount of time needed to generate the trained neural network model due to the increase in number of samples.

In accordance with one or more examples described in this disclosure, the one or more processors may select a subset of samples from a first batch of the plurality of batches based on a sample selection criteria, and store the subset of the samples for one or more of the plurality of sequential batches in memory. For a second batch (e.g., the most recent one of the batches), the one or more processors may train the neural network model to predict the one or more parameters using the samples of the second batch and the subset of the samples stored in the memory. In some examples, the subset of samples are samples from the first batch and/or other previous batches.

As one example, the sample selection criteria includes samples from the first batch that have relatively low system performance compared to other samples in the first batch or the memory. System performance may be a measure of throughput, bit error rates, etc.

For instance, within the first batch, there may be a plurality of samples (e.g., snapshots). For each sample (e.g., snapshot), there may be performance values associated with the wireless communication system, such as throughput and bit error rate. As one example, the one or more processors may store N numbers of samples that have lower system performance compared to other samples in the first batch. In some examples, N is equal to 10.

In some examples, the sample selection criteria is based on a bilevel optimization formulation that selects the subset of samples for storage within the memory. For instance, the one or more processors may perform an iterative process for updating a neural network model and determining which samples are associated with the low system performance, and reupdating the neural network model and redetermining which samples are associated with the low system performance, until there is convergence. The samples of the first batch that led to the convergence may be the subset of samples of the first batch that are stored and used for training the neural network model for the second batch. For example, the one or more processors may train the neural network model for the second batch using samples from the second batch and the subset of samples of the first batch that were stored in memory.

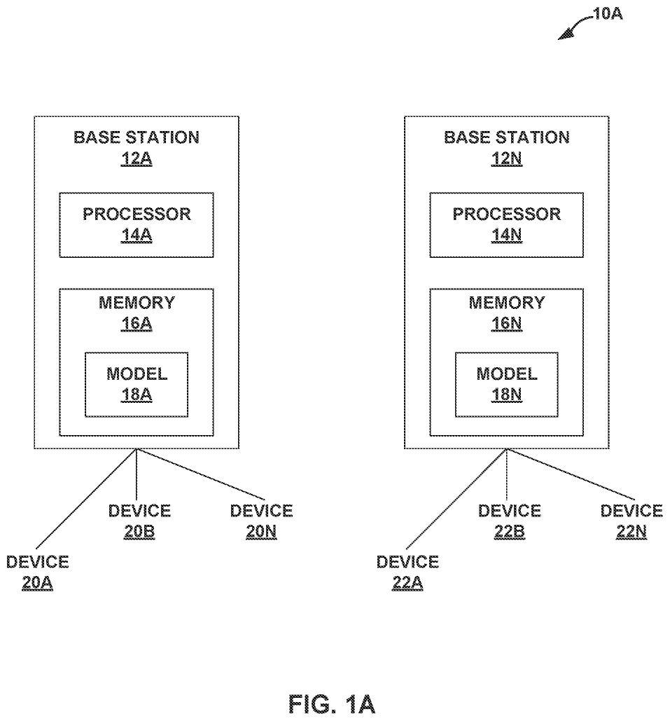

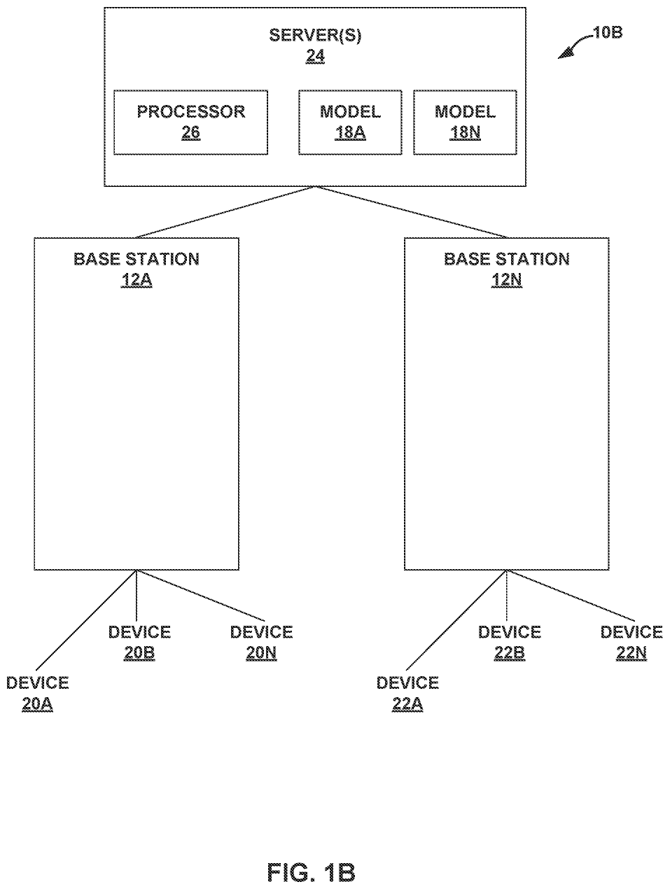

FIGS. 1A and 1B are block diagrams of example wireless communication systems 10A and 10B, respectively, in accordance with one or more examples described in this disclosure. FIGS. 1A and 1B illustrate base stations 12A and 12N. Base station 12A is configured to wirelessly communicate with devices 20A-20N, and base station 12B is configured to wirelessly communicate with devices 22A-22N.

FIGS. 1A and 1B illustrate a snapshot of wireless communication systems 10A and 10B. For example, there may be a channel state information (CSI) of the communication links between devices 20 and base station 12A and devices 22 and base station 12B, and FIGS. 1A and 1B capture an instance of that the CSI. Also, the location of devices 20 and devices 22 is the location of devices 20 and devices 22 for this snapshot. In this disclosure, the term “sample” is used to refer to the information of wireless communication systems 10A or 10B (e.g., configuration information, characteristics, environment information, etc.) at a snapshot, such as the CSI, number of devices on base stations, location of the devices, etc.

In the example of FIG. 1A, processor 14A of base station 12A may be configured to determine one or more parameters for the communication link between devices 20 and base station 12A, and processor 14B of base station 12B may be configured to determine one or more parameters for the communication link between devices 22 and base station 12B. In the example of FIG. 1B, processor 26 of one or more servers 24 may be configured to determine one or more parameters for the communication link between devices 20 and base station 12A, and the one or more parameters for the communication link between devices 22 and base station 12B.

Examples of the one or more parameters include power parameters, beamforming parameters, multicasting parameters, multiuser detection, channel estimation parameters, spectrum sensing parameters, or spectrum/channel/antenna allocation parameters, as a few non-limiting examples. In some examples, the one or more parameters may be an estimate of channel state information for a wireless channel of the wireless communication system. Based on the one or more parameters, the one or more processors (e.g., processor 14A, 14B, or 26) may allocate resources within wireless communication system 10A or 10B. As one example, the one or more processors may be configured to control an allocation of power to plurality of base stations 12A and 12N of the wireless communication system 10A or 10B for a given geographic region based on the predicted one or more parameters. As another example, the one or more processors may be configured to control beamforming for a plurality of antennas (e.g., of base stations 12A and 12N) of the wireless communication system 10A or 10B based on the predicted one or more parameters.

To determine the one or more parameters, the one or more processors may utilize a neural network model. For example, FIGS. 1A and 1B illustrate model 18A and 18N, which are examples of neural network models, such as a deep neural network (DNN) model. Other types of models are possible. In general, models 18A and 18N are examples of machine learning-based generated models that are used to predict parameters. In some examples, models 18A and 18N may be models generated from continuous learning (CL) based machine learning. In FIG. 1A, models 18A and 18N are illustrated as being stored in memory 16A and 16N, respectively. In FIG. 1B, models 18A and 18N may be stored in memory of server(s) 24.

In one or more examples, to train models 18A and 18N, the one or more processors (e.g., processor 14A, 14B and/or processor 26) may be configured to receive samples of wireless communication systems 10A or 10B, and train models 18A and 18N using the received samples. However, the distribution of wireless communication systems 10A and 10B may change. That is, the statistical distribution of some samples characterizing the environment of wireless communication systems 10A and 10B is time-varying.

For example, devices 20 and devices 22 may move from their current locations. For instance, if devices 20 or 22 are phones, as a user of the phone moves, the location of devices 20 and 22 may change. Moreover, there may be new devices added to base station 12A or 12B, or devices removed from base station 12A or 12B. The interference or other channel-quality metrics may also change.

In this disclosure, the term episode or time episode is used to describe a period of statistical distribution, where during any given time episode, the statistical distribution of some samples of the wireless communication system may not change. That is, the environment, configuration, etc. of wireless communication system 10A or 10B may not change over the episode. However, the boundaries of when the statistical distribution/time episodes of the wireless communication system may change is not known, and the length of time per statistical distribution/time episodes is not known.

Accordingly, there may be benefit in updating models 18A and 18N to account for the change the distribution. However, relying on only the current samples (e.g., most recent snapshot) to update models 18A and 18N may not result in trained models that are optimal at predicting parameters. For example, it may be possible to adopt a transfer learning (TL) and/or online learning paradigm, by updating model 18A and 18N according to samples generated from the changed distribution. However, these approaches usually degrade or even overwrite the previously learned models. Therefore, they are sensitive to outlier because once adapted to a transient (outlier) environment/task, the performance of model 18A or 18N on the existing environment/task can degrade significantly. Such kinds of behavior may be undesirable for wireless resource allocation tasks, because the unstable model performance would cause large outage probability for communication users (e.g., devices 20 and 22).

Also, relying on too many previous samples to update models 18A and 18N may result in requiring too large of memory 16A and 16N, and result in excessive long to update models 18A and 18B. For example, if the entire model 18A or 18N is periodically retrained using all the samples seen so far, then the training can be time and memory consuming since the number of samples needed keeps growing.

This disclosure describes examples, data-driven models 18A or 18N that can adapt to the new environment efficiently (i.e., by using as little resource as possible), seamlessly (i.e., without knowing when the environment of the wireless communication system has been changed), quickly (i.e., adapt well using only a small amount of samples), and continually (i.e., without forgetting the previously learned models). In accordance with one or more examples described in this disclosure, the one or more processors may be configured to receive samples of the wireless communication system over a plurality of sequential batches, where each of the batches represents a different, non-overlapping period of time. For instance, each time episode can be composed of one or multiple batches. In one or more examples, the length of time per batch may be known (e.g., preset or otherwise set, e.g. batch can in order of seconds or milliseconds or others). In some examples, during any given batch, the statistical distribution of some samples of the wireless communication system may not change.

In at least some examples, the batches do not and may not align with when there is change in the distribution of wireless communication system 10A or 10B (e.g., might not align at boundaries of episodes). That is, in one or more examples, the one or more processors may not have any a priori information of when there will be change in the distribution of the wireless communication systems 10A or 10B.

For each of the batches, the one or more processors may be configured to perform continuous learning. For example, to train models 18A or 18N for a current batch, the one or more processors may use a subset of samples from a previous batch. As described in more detail, the one or more processors may utilize a sample selection criteria to select the subset of samples from the previous batch that are stored in the memory, and then possibly used for training models 18A or 18N for the current batch.

For example, the one or more processors may select, based on a sample selection criteria, a subset of the samples from a first batch (e.g., previous batch) of the plurality of batches as representative samples for the first batch. As described in more detail, the sample selection criteria may be based on a system performance metric computed for each of the samples. The one or more processors may store the subset of the samples for one or more of the plurality of sequential batches in the memory. Examples of the memory include memory 16A, 16N, or memory in server(s) 26, but any memory may be possible.

Upon receiving samples for a second batch (e.g., current batch), the one or more processors may train the neural network to generate model 18A or 18N to predict the one or more parameters using the samples from the second batch (e.g., current batch) and the subset of the samples stored in the memory. For example, at the start of the current batch, for an initial period of time, the one or more processors may receive samples of the current batch and access from memory the subset of the samples of the previous batch(es). The one or more processors may utilize both the samples for the current batch and the subset of samples of the previous batch(es) to train model 18A or 18N.

In some examples, the sample selection criteria used to determine the subset of samples from the first batch (e.g., previous batch) may be a criteria that defines that samples in first batch that have relatively low system performance compared to other samples in the first batch should be stored. This example of the sample selection criteria may be referred to as “sample fairness criteria.” Examples of the system performance include throughput rate and bit error rate, and low system performance may refer to samples where the throughput rate is low or the bit error rate is high.

In some examples, the sample selection criteria is based on a bilevel optimization formulation that selects the subset of samples for storage within the memory. Examples of the bilevel optimization formulation is described in more detail, and may be used in combination with the sample fairness criteria or other example criterion. The above are some example techniques for sample selection criteria, but the techniques are not so limited. Additional examples of the sample selection criteria include time fairness criteria, where the same amount of samples are selected from each batch, or randomness criteria, where the selection of samples is random.

The learning based techniques described in this disclosure may provide advantages over some continuous learning techniques. For example, continual learning (CL) may address the “catastrophic forgetting phenomenon” of losing information of previous samples. That is, the tendency of abruptly losing the previously learned models when the current environment information of the wireless communication system (e.g., where the distribution may change) is incorporated may be addressed. Specifically, consider the setting where different “tasks” (e.g., different CSI distributions) are revealed sequentially. Then CL aims to retain the knowledge learned from the early tasks through one of the following mechanisms: 1) regularize the most important parameters; 2) design dynamic neural network architectures and associate neurons with tasks; or 3) introduce a small set of memory for later training rehearsal. However, most of these CL techniques require the knowledge of the task boundaries (e.g., boundaries of episodes), that is, the timestamp where an old task terminates and a new task begins. However, such a setting does not suit wireless communication problems well, since the wireless environment usually changes continuously, without a precise changing point. Only limited recent CL works have focused on boundary-free environments, but they all focus on proposing general-purpose tools without considering any problem-specific structures. Therefore, it is unclear whether they will be effective in wireless communication tasks.

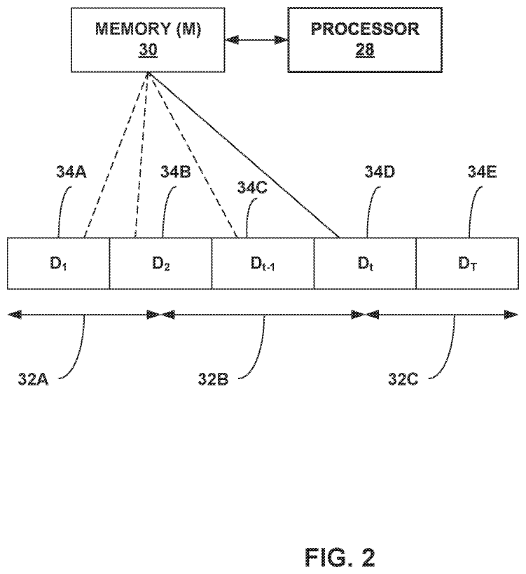

FIG. 2 is a conceptual diagram of an example wireless communication system configured for continuous learning (CL) in various environments, including episodically dynamic environments. FIG. 2 illustrates processor 28, which is an example of processor 14A-14N (FIG. 1A) or processor 26 (FIG. 1B), and memory 30, which is an example of memory 16A or 16N, or memory of server 24.

FIG. 2 illustrates episodes 32A-32C, which are each a certain amount of time. In each of episodes 32A-32C, the distribution (e.g., configuration information, channel information, and other characteristics of the operation of wireless communication system 10A or 10B may be the same). However, the distribution may change from episode-to-episode. In one or more examples, the length of time of each of episodes 32A-32C may not be known and may vary.

Each of episodes 32A-32C may include one or more batches 34A-34E, shown as D₁ to D_{T}. Each of batches 34A-34E need not align with episodes 32A-32C. For example, batch 34B (D₂) crosses episodes 32A and 32B. The length of time of batches 34A-34E may be known (e.g., preset or determined in some other way).

FIG. 2 illustrates an example in which processor 28 is configured to determine a model (e.g., like model 18A or 18N) for batch 34D (Dₜ). For instance, as illustrate with dashed lines and in accordance with one or more examples described in this disclosure, for batches 34A-34C, processor 34 may select a subset of samples from batches 34A-34C for storing in memory 30. Processor 34 may utilize a sample selection criteria described in more detail to select the subset of samples. Processor 34 may utilize samples from batch 34D (Dₜ), and the samples stored in memory 30 to train the neural network and generate a model (e.g., like model 18A or 18N) for determining parameters of the wireless communication system for batch 34D (Dₜ).

In the example of FIG. 2, data (e.g., samples) are processed in a sequential manner (e.g., processor 28 processing data Dₜ at time t), with changing episodes and distributions. In this example, an input model has a limited memory set M, which for purposes of example is assumed to have a capacity less than would be required to store all data D₁ to Dₜ. To maintain the performance over all experienced data from D₁ to Dₜ, processor 28 is configured to further train and optimize data-driven deep neural network (DNN) model 18A or 18N at each time t, based on the mixture of the current data Dₜ and the memory set M. The memory set M is then updated to incorporate the new data Dₜ.

By introducing continual learning (CL) into a machine learning-based modeling process, processor 28 is able to seamlessly and efficiently adapt to the episodically dynamic environment, without knowing the episode boundary, and importantly, maintain high performance over previously encountered scenarios.

The techniques described herein are validated through two typical wireless resource allocation problems (one for power control and one for beamforming), and use both synthetic and ray-tracing based data sets. Simulation results show that the described methods and systems are consistently better than naive transfer learning methods, and achieve better performance than conventional CL-based approaches. Empirical results indicate that the example techniques can be extended to many other related problems.

In general, the techniques enable memory-based continual learning system for wireless communication, including usage of a small subset of historical data for future training rehearsal/re-training. DNN model 18A or 18N seamlessly and efficiently adapts to the changing environment, while maintaining the previously learned knowledge, and without knowing the episode boundaries, which refers to a time point that the environment changes.

As shown in FIG. 2, in some examples, a memory block M is included in the entire machine learning pipeline. Moreover, new ways to train the machine learning based communication system are described. Once data is received at time t, memory (with fixed size M) is filled with the most representative samples from all experienced data. DNN model 18A or 18N is re-optimized (e.g., trained), at each time t, based on the mixture of the current data and the memory set M. The memory set M is then updated to incorporate the new data.

As such, FIG. 2 illustrates a design of a data-driven machine learning pipeline that enables continually optimizing wireless system. The learner (e.g., processor 28) does not need to know when the data distribution will change in order to retrain the neural network to generate model 18A or 18N (that is, the boundary-free setting). Rather, using the techniques described herein, processor 28 can keep updating memory M and keep training model 12 as data comes in.

An additional technical advantage achieved by the techniques of this disclosure is that training complexity will be made much smaller than performing a complete training of model 18A or 18N over the entire historical data set and will be comparable with an approach that only uses current data rather than at least some historical data. Moreover, if the size of a given data batch D is fairly small, the learner (processor 28) is unlikely to overfit because the size of memory M is kept as fixed during the entire training process. This makes the machine learning-based training algorithms more robust than transfer learning techniques, for example.

Another technical advantage of the techniques described herein is, in some examples, the tailored selection for memory set M. In such examples, techniques are used to select a small set of important data samples for injection into working memory M based on certain data-sample fairness criterion or bilevel-based formulation.

For example, this disclosure describes example techniques for the notion of CL to data-driven wireless system design, and develop a tailored CL formulation together with a training algorithm. For instance, the one or more processors may consider an “episodically dynamic” setting where the environment changes in episodes, and within each episode the distribution of the CSIs stays relatively stationary. The one or more processors may train model 18A or 18N which can seamlessly and efficiently adapt to the changing environment, while maintaining the previously learned knowledge, and without knowing the episode boundaries of the distribution (e.g., when the distribution changed).

This disclosure describes CL framework for wireless systems, which incrementally adapts the models 18A or 18N by using samples from the new batch (e.g., current batch or second batch) as well as a limited but carefully selected subset of data from the previous batches (e.g., previous batch or first batch), as described above with respect to FIGS. 1A, 1B, and 2. Compared with the existing heuristic boundary-free CL algorithms, the example techniques are based upon a clearly defined optimization formulation that is may be used for the wireless resource allocation problem.

For example, the CL method is based on a bilevel optimization which selects a small set of important data samples into the working memory according to certain data-sample fairness criterion. In some examples, the lower level of constrained non-convex bilevel problem may be relaxed using a smooth approximation, and there may be analysis of practical (stochastic) algorithms for model training.

As described above, one or more processors (e.g., processor 14A, 14B, 26, or 28) may be configured to train model 18A or 18N. The following describes some example training techniques.

Deep learning can be divided into two categories: end-to-end learning and deep unfolding. In end-to-end learning, DNNs can be exploited to learn the optimization algorithms such as WMMSE, in an end-to-end fashion. Also, unsupervised learning can be used to further improve the model performance. Different network structures, such as convolutional neural networks and graph neural networks, and different modeling techniques, such as reinforcement learning, may also be used. These example techniques belong to the category of end-to-end learning, where a black-box model (typically deep neural network) is applied to learn either the structure of some existing algorithms, or the optimal solution of a communication task. In deep unfolding, deep unfolding based methods unfold existing optimization algorithms iteration by iteration and approximate the per-iteration behavior by one layer of the neural network.

The following describes continual learning (CL) techniques. CL is originally proposed to improve reinforcement learning tasks to help alleviate the catastrophic forgetting phenomenon, that is, the tendency of abruptly losing the knowledge about the previously learned task(s) when the current task information is incorporated, as described above. It may be used to improve other machine learning models, and specifically the DNN models. Generally, the CL paradigm can be classified into the following categories.

1) Regularization Based Methods: Based on the Bayesian theory and inspired by synaptic consolidation in Neuroscience, the regularization based methods penalize the most important parameters to retain the performance on old tasks. However, regularization or penalty based methods naturally introduce tradeoff between the performance of old and new tasks. If a large penalty is applied to prevent the model parameters from moving out of the optimal region of old tasks, the model may be hard to adapt to new tasks; if a small penalty is applied, it may not be sufficient to force the parameters to stay in the optimal region to retain the performance on old tasks.

2) Architectures Based Methods: By associating neurons with tasks (either explicitly or not), there may be different types of dynamic neural network architectures to address the catastrophic forgetting phenomenon. However, due to the nature of the parameter isolation, architecture based methods usually require the knowledge of the task boundaries, and thus they are not suitable for wireless settings, where the environment change is often difficult to track.

3) Memory Based Methods: Memory based methods store a small set of samples in memory for later training rehearsal, either through selecting and storing the most represented samples or use generative models to generate representative samples. However, all above methods require the knowledge of the task boundaries, which are not suitable for wireless settings (e.g., as boundaries of when samples change is not known). Again, in one or more examples, the batches may be known, but whether is change or how much change in the distribution (e.g., boundaries of the episodes) may not be known.

Some boundary-free methods include selecting the samples through random reservoir sampling, which fills the memory set with data that is sampled from the streaming episodes uniformly at random. More complex mechanisms may further increase the sampling diversity, where the diversity is measured by either the samples' stochastic gradient directions or the samples' Euclidean distances.

The following provides examples of episodic wireless environment in which the distribution (e.g., characteristics of the environment of the wireless communication system) can change. As described above, models 18A and 18N may be based on learning algorithms in a dynamic wireless environment, so that the models 18A and 18N are built seamlessly, efficiently, and continually adapt to new environments. This following describes details about what is considered dynamic environment, and discuss potential challenges.

The one or more processors may perform operation for an “episodically dynamic” setting where the environment changes relatively slowly in “episodes,” and during each episode the learners (e.g., the one or more processors) observe multiple batches of samples generated from the same stationary distribution (e.g., as shown in FIG. 2).

In FIG. 2, Dₜ denotes a small batch of data collected at time t, and assume that each batch k contains a set of Tk batches, and use Ek={Dt}t∈Tk to denote the data collected in batch k. As an illustration about the setting, consider the following example. Again, there may be no knowledge about the boundaries where there is change.

Suppose a collection of base stations (BSs) 12A to 12N run certain DNN based resource allocation algorithm to provide coverage for a given area (e.g., a shopping mall). The users' activities can contain two types of patterns: 1) regular but gradually changing patterns—such as daily commute for the employees and customers, and such a kind of pattern could slowly change from week to week (e.g., the store that people like to visit in the summer is different in winter); 2) irregular but important patterns—such as large events (e.g., promotion during the anniversary season), during which the distribution of user population (and thus the CSI distribution) will be significantly different compared with their usual distributions, and more careful resource allocation has to be performed. The episode, in this case, can be defined as “a usual period of time”, or “an unusual period of time that includes a particular event”.

Suppose that each BS solves a weighted sum-rate (WSR) maximization problem for single-input single-output (SISO) interference channel, with a maximum of K transmitter and receiver pairs. Let hₖₖ∈C denote the direct channel between transmitter k and receiver k, and hᵢⱼ∈C denote the interference channel from transmitter j to receiver k. The power control problem aims to maximize the weighted system throughput via allocating each transmitter's transmit power pₖ. For a given snapshot of the network, the problem can be formulated as the following:

$${max}_{{p}_{1} , … , {p}_{K}} R ( p ; h ) := {{\sum }^{K}}_{k = 1} {α}_{k} log ( 1 + \frac{{\vert {h}_{kk} \vert}^{2} {p}_{k}}{{\sum }_{j \neq k} {\vert {h}_{kj} \vert}^{2} {p}_{j} + {σ}_{k}^{2}} ) \\ s . t . 0 \leq {p}_{k} \leq {P}_{max} , ∀ k = 1 , 2 , … , K , \qquad ( 1 )$$

where Pmax denotes the power budget of each transmitter; {αk>0} are the weights. Equation (1) is known to be NP-hard but can be effectively approximated by many optimization algorithms. The data-driven methods train DNNs using some pre-generated dataset; here, Dₜ can include a mini-batch of channels {hₖⱼ}, and each episode can include a period of time where the channel distribution is stationary.

For illustration purposes, consider the following scenario. At the beginning of a batch, a DNN model for solving problem (1) (pretrained using historical data, D0) is preloaded on the BSs to capture the regular patterns in the shopping mall area. However, it may be unclear the operation of the BSs when the unexpected patterns appear. For instance, assume every morning a “morning model” is loaded to allocate resources up until noon. During this time the BSs can collect batches of data Dₜ, t=1, 2, . . . . Then, it is unclear if the BS updates its “morning model” immediately to capture the dynamics of the user/demand distribution. If such updates are appropriate, it is unclear if the entire data set, including the historical data and the real-time data, should be used to re-train the neural network (which can be time-consuming), or should another technique be used to adapt to the new environment on the fly, which may result in overwritten the basic “morning model”.

This disclosure describes examples to adopt the notion of CL, so that model 18A or 18N can incorporate the new data Dₜ on the fly, while keeping the knowledge acquired from D_{0:t-1}.

The following describes CL for learning wireless resource. The example techniques are based upon the memory-based CL, which allows the learner (e.g., the one or more processors) to collect a small subset of historical data for future re-training. For instance, once Dₜ is received, the one or more processors may fill the memory Mₜ (with fixed size) with the most representative samples from all experienced batches D_{0:t-1}, and then train the neural network (e.g., model 18A or 18N) at each time t with the data Mₜ∪Dₜ.

Several example features of such techniques are as follows. The learner (e.g., one or more processors) does not need to know where a new boundary starts (e.g., when there is a change in distribution). In other words, the example techniques allow for boundary-free setting. The one or more processors can keep updating Mₜ and keep training as samples come in. If the size of the memory can be set, then the training complexity may be made much smaller than performing a complete training over the entire data set D_{0:t}, and will be comparable with TL approach which uses Dₜ. Also, if the size of a given data batch Dₜ is very small, the learner (e.g., one or more processors) is unlikely to overfit because the memory size is kept as fixed during the entire training process. This makes the algorithm more robust than the TL technique.

As described above, some techniques may utilize random reservoir sampling algorithm, and sample diversity methods. However, such techniques may have drawbacks. First, for the reservoir sampling, if certain episode only contains a very small number of samples, then samples from this episode will be poorly represented in Mₜ because the probability of having samples from an episode in the memory is only dependent on the size of the episode. Second, for the diversity based methods, the approach is again heuristic, since it is not clear how the “diversity” measured by large gradient or Euclidean distances can be directly linked to the quality of representation of the dataset. Third, the ways that the memory sets are selected are independent of the actual learning tasks at hand. The last property makes these algorithms broadly applicable to different kinds of learning tasks, but also prevents them from exploring application-specific structures.

This disclosure describes a new memory-based CL formulation there is direct use features of the learning problem at hand to build our memory selection mechanism. For instance, the following describes for two ways of formulating the training problem for learning optimal wireless resource allocation. First, an unsupervised learning approach may be adopted, which directly optimizes some native measures of wireless system performance, such as the throughput, Quality of Service, or the user fairness, and this approach does not need any labeled data. Specifically, a DNN training problem is given by

$${min}_{Θ} ℓ ( Θ ; {h}^{( i )} ) , \qquad ( 2 )$$

where h(i) is the ith CSI sample; Θ is the DNN weight to be optimized; £(⋅) is the negative of the per-sample sum-rate function, that is: £(Θ; h(i))=−R(π(Θ; h(i)); h(i)), where R is defined in (1) and π(Θ; h(i)) is the output of DNN which predicts the power allocation. The advantage of this class of unsupervised learning approach is that the system performance measure is directly built into the learning model, while the downside is that this approach can get stuck at low-quality local solutions due to the non-convex nature of DNN. In some examples, the one or more processors may utilize such a technique for training model 18A or 18N.

Secondly, it is also possible to use a supervised learning approach. Towards this end, there may be some labeled data by executing a state-of-the-art optimization algorithm over all the training data samples. Specifically, for each CSI vector h(i), the one or more processors may use algorithms such as the WMMSE to solve equation (1) and obtain a high-quality solution p(i). Putting the h(i) and p(i) together yields the ith labeled data sample. Specifically, a popular supervised DNN training problem is given by:

$${min}_{Θ} ℓ ( Θ ; {h}^{( i )} , {p}^{( i )} ) , \qquad ( 3 )$$

where £(⋅) is the Mean Squared Error (MSE) loss, that is: £(Θ; h(i), p(i))=p(i)−π(Θ, h(i))². Such a supervised learning approach typically finds high-quality models but often incurs significant computation cost since generating labels can be very time-consuming. Additionally, the quality of the learning model is usually limited by that of label-generating optimization algorithms.

In some examples, the one or more processors may leverage the advantages of both training approaches to construct a memory-based CL formulation (e.g., to train models 18A and 18N). For instance, the one or more processors may select the most representative data samples h(i)'s into the memory, by using a sample fairness criteria. That is, those data samples that have relatively low system performance are more likely to be selected into the memory. Meanwhile, the DNN (e.g., by the one or more processors to train models 18A or 18N) is trained by performing either supervised or unsupervised learning over the selected data samples. The subset of under-performing data samples is selected to represent a given episode. In some examples, as long as a learning model can perform well on those under-performing samples, then it should perform well for the rest of the samples in a given episode.

To proceed, assume that the entire dataset D_{0:T} is available. Use £(⋅) to denote a function measuring the per-sample training loss, u(⋅) a loss function measuring system performance for one data sample, Θ the weights to be trained, h(i) the ith data sample and p(i) the ith label. Let π(Θ; h(i)) denote the output of the neural network.

The following describes a bilevel optimization problem:

$${min}_{Θ} {λ}_{*}^{( i )} ( Θ ) \cdot ℓ ( Θ ; {h}^{( i )} , {p}^{( i )} ) \qquad ( 4 a )$$

$$s . t . {λ}_{*} ( Θ ) = arg {λ}^{( i )} \cdot u ( Θ ; {h}^{( i )} , {p}^{( i )} ) , \qquad ( 4 b )$$

$$where denotes the simplex constraint$$

$$:= \{ λ \vert {λ}^{( i )} = 1 , {λ}^{( i )} \geq 0 , ∀ i ∈ {0 : T}_{} \} .$$

In the above formulation, the upper level problem (4a) optimizes the weighted training performance across all samples, and the lower level problem (4b) assigns larger weights to those data samples that have higher loss u(⋅) (or equivalently, lower system level performance). The lower level problem has a linear objective, so the optimal λ* is always on the vertex of the simplex, and the non-zero elements in λ* all have the same weight. Such a solution naturally selects a subset of data for the upper-level training problem to optimize.

The following describes choices of loss functions. One feature of the above formulation is that the training problem and the data selection problem are decomposed, so that there is flexibility of choosing different loss functions according to the applications at hand. The following are few examples for alternatives that may be separate or combined with other techniques described in this disclosure.

First, the upper layer problem trains the DNN parameters Θ, so any existing training formulation discussed above can be adopted. For example, if supervised learning is used, then one common training loss is the MSE loss:

l_{MSE}(Θ;h⁽ⁱ⁾,p⁽ⁱ⁾)=∥p⁽ⁱ⁾−π(Θ,h⁽ⁱ⁾)∥². (5)

Second, the lower loss function u( ) can be chosen as some adaptive weighted negative sum-rate for the iₜₕ sample, which is directly related to system performance:

u_{WSR}(Θ,h⁽ⁱ⁾,p⁽ⁱ⁾)=−αᵢ(Θ;h⁽ⁱ⁾,p⁽ⁱ⁾)·R(π(Θ,h⁽ⁱ⁾);h⁽ⁱ⁾). (6)

If αᵢ(Θ;h⁽ⁱ⁾,p₍ᵢ₎)≡1, ∀l, is chosen, then the channel realization that achieves the worst throughput by the current DNN model may always be selected, and the subsequent training problem may try to improve such “worst case” performance. Alternatively, when the achievable rates at samples across different episodes vary significantly (e.g., some episodes can have strong interference), then it is likely that the previous scheme will select data only from a few episodes. Alternatively, the following may chosen: αi (Θ; h(i), p(i))=1/R (h(i)), where R (h(i)) is the rate achievable by running some existing optimization algorithm on the sample h(i). This way, the data samples that achieve the worst sum-rate “relative” to the state-of-the-art optimization algorithm is more likely to be selected. Empirically the ratio R(π(Θ, h(i)); h(i))/R (h(i)) should be quite uniform across data samples, so if there is one sample whose ratio is significantly lower than the rest, then it may be considered as “underperforming” and selected for storing into the memory.

The following describes an example of special case. As a special case of problem (4), one can choose £( ) to be the same as u( ). Then the bilevel problem reduces to the following minimax problem, which optimizes the worst case performance (measured by the loss £(⋅))) across all samples:

$${min}_{Θ} {λ}^{( i )} \cdot ℓ ( Θ ; {h}^{( i )} , {p}^{( i )} ) \qquad ( 7 )$$

When £(⋅) is taken as the negative per-sample sum-rate defined in (2), problem (7) is related to the classical minimax resource allocation, with one example difference that it does not achieve fairness across users, but rather to achieve fairness across data samples. Compared to the original bilevel formulation (4), the mini-max formulation (7) is more restrictive but its properties have been relatively better understood.

At this point, neither the bilevel problem (4) nor the minimax formulation (7) can be used to design CL strategy yet, because solving these problems requires the full data D_{0:T}. To make these formulations useful for the considered CL setting, the following approximation is made. Suppose that at t-th time instance, the memory Mt and the new data set Dt is available. Then, to solve the following problem to identify data candidates at time t, the following is proposed:

$${min}_{Θ} {λ}_{t}^{( i )} ( Θ ) \cdot ℓ ( Θ ; {h}^{( i )} , {p}^{( i )} ) \qquad ( 8 )$$

$$s . t . {λ}_{t} ( Θ ) = arg {λ}^{( i )} \cdot u ( Θ ; {h}^{( i )} , {p}^{( i )} ) ,$$

$$where {}_{t} denotes the simplex constraint$$

$${t}_{} := \{ λ \vert {λ}^{( i )} = 1 , {λ}^{( i )} \geq 0 , ∀ i ∈ {t}_{} ⋃ {t}_{} \} .$$

In some examples, at a given time t, the one or more processors may collect M data points j∈Mₜ∪Dₜ hose corresponding λ(j)'s are the largest. These data points will form the next memory Mt+1, and problem (8) will be solved again; See Algorithm 1 below.

Algorithm 1: Bilevel Based CL Framework

| 1 | Input: Memory [symbol] ₀ = ∅. memory size M , max iterations R, | | |
|---|---|---|---|
| | step-sizes α, β | | |
| 2 | while receive [symbol] ₜ do | | |
| 3 | \| | [symbol] ₜ = [symbol] ₜ ∪ [symbol] ₜ | |
| 4 | \| | for k = 1 : K do | |
| 5 | \| | \| | Θ^{k+1} ← Θ^{k} − αₖ∇g(Θ^{k}; ϕ^{k})∇₁f(y^{k+1}; Θ^{k}; ξ^{k}) |
| 6 | \| | \| | −αₖ∇₂f(y^{k+1}; Θ^{k}; ξ^{k}) |
| 7 | \| | \| | y^{k+1} ← (1 − βₖ) (y^{k} + g(Θ^{k}; ϕ^{k}) − g(Θ^{k-1}; ϕ^{k})) |
| 8 | \| | \|_{—} | +βₖg(Θ^{k}; ϕ^{k}) |
| 9 | \| | if \| [symbol] ₜ\| < M then | |
| 10 | \| | \| | [symbol] ₜ₊₁ = [symbol] ₜ |
| 11 | \| | else | |
| 12 | \| | \| | [symbol] = Top_{M}({λₜ⁽ⁱ⁾}_{∀i}) |
| 13 | \| | \|_{—} | [symbol] ₜ₊₁ = { [symbol] ₜ⁽ⁱ⁾ [symbol] |
| | \|_{—} | | |

The above described examples of a CL framework and its optimization formulations. The following describes practical (stochastic) algorithms to solve those problems, and provide some analysis.

The constrained non-convex bilevel problem (8) is a challenging problem. In one or more examples, instead of directly solving the bilevel problem, it may be possible to relax the original non-convex constrained lower level problem using softmax function, which is a smooth approximation of the argmax function:

$${min}_{Θ} {λ}_{⋆}^{( i )} ( Θ ) \cdot ℓ ( Θ ; {h}^{( i )} , {p}^{( i )} ) \\ s . t . {λ}_{*}^{( i )} ( Θ ) = ∈ ( 0 , 1 ) , ∀ i . \qquad ( 9 )$$

After using the above approximation, λ is now implicitly constrained and can be computed in a closed-form. The obtained λ*(Θ) may still allocate larger weights to larger loss values u(⋅). Further, there may not be a need to solve two problems simultaneously, since it may be possible to obtain a single-level problem by plugging the lower level problem into the upper problem.

Formally, the above problem can be written as the following compositional optimization form:

$${min}_{Θ} F ( Θ ) = \overline{f} ( \overline{g} ( Θ ) ; Θ ) , \qquad ( 10 )$$

$$where we have defined :$$

$$\overline{f} ( z ; Θ ) := \frac{{e}^{u ( Θ ; {h}^{( i )} , {p}^{( i )} )} \cdot ℓ ( Θ ; {h}^{( i )} , {p}^{( i )} )}{} , \qquad ( 11 a )$$

$$\overline{g} ( Θ ) := \frac{1}{} \cdot {e}^{u ( Θ ; {h}^{( i )} , {p}^{( i )} )} . \qquad ( 11 b )$$

The following describes optimization algorithms and convergence. The followed describes algorithms for the above problem. The following are some standard assumptions. Assumption 1 (Boundedness). The function value, the gradient and the Hessian of both upper level function £(⋅) and lower level function u(⋅) are bounded, that is,

£(Θ;h,p)≤Ce0,u(Θ;h,p)≤Cu0,

∇Θ£(Θ;h,p)≤Ce1,∇Θu(Θ;h,p)≤Cu1

∇Θ£(Θ;h,p)≤Ce2,

∇Θu(Θ;h,p)≤Cu2.

Since the compositional problem (10) is essentially a single-level problem, it is possible to update the variable Θ using the conventional gradient descent (GD) algorithm:

Θ^{k+1}=Θ^{k}−α∇g̅(Θ^{k})∇₁f̅(g̅(Θ^{k});Θ^{k})−α∇₂f̅(g̅(Θ^{k});Θ^{k}), (12)

where α is the stepsize, ∇₁ and ∇₂ are defined as follows

∇₁f̅(a,⋅)=∂f̅(a,⋅)/∂a

∇₂f̅(,b)=∂f̅(⋅,b)/∂b

The result is the following convergence result.

If the Assumption 1 hold, then the GD update (12) achieves the following rate min∥F(Θ^{t})∥²≤c0·L·(F(Θ⁰)−F*)/K+1

0≤t≤K

where c0 is some universal positive constant, L is the Lipschitz constant of function ∇F (Θ), and F* is the optimal value of F(⋅).

From assumption 1, it can be concluded that the function F is Lipschitz continuous gradient with constant L. Then the result immediately follows the classical gradient descent analysis on non-convex problems.

However, the above update requires the evaluation of g (Θ), ∇g (Θ) and ∇f (z, Θ), and the evaluation of each term re-quires the entire dataset Mt∪Dt. This may mean that performance of full gradient descent to train a (potentially large) neural network may be needed, which is computationally expensive, and typically results in poor performance.

A more efficient solution is to perform a stochastic gradient descent (SGD) type update, which first samples a mini-batches of data, then computes stochastic gradients which is used for the update. To be specific, the algorithm samples a subset of data ξ and φ randomly at each iteration from the dataset Mt∪Dt. Then the sampled versions of f (z; Θ) and g (Θ) are given by:

$$f ( z ; Θ ; ξ ) := \frac{{\sum }_{i ∈ ϵ} {e}^{u ( Θ ; {h}^{( i )} , {p}^{( i )} )} \cdot ℓ ( Θ ; {h}^{( i )} , {p}^{( i )} )}{\vert ξ \vert \cdot z} , \qquad ( 13 a )$$

$$g ( Θ ; ϕ ) := \frac{1}{\vert ϕ \vert} \cdot {\sum }_{i ∈ ϕ} {e}^{u ( Θ ; {h}^{( i )} , {p}^{( i )} )} , \qquad ( 13 b )$$

where the notations |φ| and |ξ| denote the number of samples in the mini-batch φ and ξ, respectively. It is common to assume that the sampling mechanism can obtain ξ and φ randomly and independently, that is, the following unbiasedness property holds.

For assumption 2, unbiased sapling, the sampling oracle satisfies the following:

[symbol]

[g(Θ;ϕ)]=g̅(Θ),

[symbol]

[∇g(Θ;ϕ)]=∇g̅(Θ),

[symbol]

[∇₁f(z;Θ;ξ)]=∇₁f̅(z;Θ)

[symbol]

[∇₂f(z;Θ;ξ)]=∇₂f̅(z;Θ).

Based on the above assumption, problem (10) can be equivalently written as:

$${min}_{Θ} F ( Θ ) = 𝔼 [ f ( 𝔼 [ g ( Θ ; ϕ ) ] ; Θ ; ξ ) ] , \qquad ( 14 )$$

where the expectation is taken on the sampling oracle. Then, the following stochastic update can be used, where the update direction d^{k} is an unbiased estimator of ∇F (Θk):

Θk+1=Θk−α∇g(Θk;φk)∇1f(Eg(Θk; k);Θk;ξ)−α∇2f(Eg(Θk;φk);Θk;ξk):=Θk−αdk,

where the following is defined:

d^{k}:=∇g(Θ^{k};ϕ^{k})∇₁f( [symbol] [g(Θ^{k};ϕ^{k})];Θ^{k};ξ^{k}) (15)

+∇₂f( [symbol] [g(Θ^{k};ϕ^{k})];Θ^{k};ξ^{k}). (16)

Computing d^{k} may still costly due to the need to evaluate E g(Θk; φk) (i.e., evaluating g (Θk)), which still involves the full data. One can no longer directly replace E g(Θk; φk) by its stochastic samples g(Θk; φ) because such an estimator is biased, that is:

[symbol]

[∇g(Θ^{k};ϕ^{k})∇₁f(g(Θ^{k};ϕ^{k});Θ^{k};ξ^{k})]≠∇g̅(Θ^{k})∇₁f̅(g̅(Θ^{k});Θ^{k}).

To proceed the auxiliary sequence {y^{k}} to track the unbiasedness in the approximation of the gradient is introduced. The resulting SGD-type algorithm is given below:

Θ^{k+1}=Θ^{k}−αₖ∇g(Θ^{k};ϕ^{k})∇₁f(y^{k+1};Θ^{k};ξ^{k}), −αₖ∇₂f(y^{k+1};Θ^{k};ξ^{k}) (17a)

y^{k+1}=(1−βₖ)(y^{k}+g(Θ^{k};ϕ^{k})−g(Θ^{k-1};ϕ^{k}))+βₖg(Θ^{k};ϕ^{k}), (17b)

where {αk} and {βk} are sequences of stepsizes. The rationale is that, if the auxiliary variable y can track the true value g (Θk) reasonably well, then (17a) will be able to approximate an unbiased estimator of the true gradient.

The proposed stochastic algorithm for problem (11) is given in Algorithm 1. In particular, the elements of {λt} (defined in (9)) are sorted and the top M largest elements' in index I are picked, and the data points associated with index I are assigned to the new memory set Mₜ₊₁.

The use of the auxiliary variable y first appeared in solving stochastic compositional optimization problems in the form of:

$${min}_{Θ} {𝔼}_{ξ} [ f ( {𝔼}_{ϕ} [ g ( Θ , ϕ ) ] , ξ ) ] , \qquad ( 18 )$$

However, problem (18) is not exactly the same as problem (14) because problem (14) includes an extra variable Θ in the definition of f(⋅), so the update (17a) includes an additional term −αk ∇2 f (y^{k+1}; Θk; ξk). Therefore, there may be more refining analysis.

The following may a consequence of assumption 1 and 2.

Lemma 1. Suppose Assumption 1-2 hold, then there is (1) The stochastic function g(Θ; φk) has bounded variance:

E[∥g(Θ;φ^{k})−g (Θ)∥²]≤Vg².

(2) The stochastic gradient of g is bounded in expectation, that is, there exist positive constants C_{g} such that

E[∥∇g(Θ;φ)∥]≤Cg. (19)

(3) The stochastic gradient of g is Lg-smooth, that is, for any Θ, Θ∈Rd, it is:

∥∇g(Θ;φ)−∇g(Θ;φ)∥≤Lg∥Θ−Θ′∥,

where φ denotes the random data sampled from and g are defined in (11) and (13), respectively.

The tracking error of the auxiliary variable y may be shrinking. Lemma 2 (Tracking Error Contraction). Consider F^{k} as the collection of random variables, i.e., F^{k}:={φ, . . . , φ, ξ, . . . , ξ} Suppose Assumption 1 and 2 hold, and y^{k+1} is generated by running iteration (17b) conditioned F^{k}. The mean square error of y^{k+1} satisfies:

[symbol]

[∥g̅(Θ^{k})−y^{k+1}∥²| [symbol] ^{k}]≤(1−βₖ)²∥g̅(Θ^{k-1})−y^{k}∥²+4(1−βₖ)²C_{g}²∥Θ^{k}−Θ^{k-1}∥²+2βₖ²V_{g}²,

where C_{g} and V_{g} are defined in Lemma 1.

Consider Algorithm 1. Suppose Assumptions 1 and 2 hold, and that the sequence of the auxiliary variable {yk} is bounded away from zero, i.e., yk≥Cy, ∀k for some positive constant Cy. Choose the stepsizes as αk=βk/L0, ∀k, where L0>0. Then the iterates {Θk} in (17) satisfy:

$$\frac{{\sum }_{k = 0}^{K - 1} 𝔼 [ {‖ ∇ F ( {Θ}^{k} ) ‖}^{2} ]}{K} \leq \frac{2 F ( {Θ}^{0} ) + 2 \tilde{C}}{\sqrt{K}} ,$$

where C is some universal constant dependent on assumptions 1, 2 and C_{y}, K is the total number of iterations executed by the algorithm.

Several significant advantages of this approach include:

Memory data selection procedure can be carefully optimized,

Data selection process can be based on a data-sample fairness-based rule. For example, the “worst performance” sample can be more likely to be picked out and put into the memory,

Fairness criterion can be formulated into a bilevel formulation, see problem (1).

The lower level of constrained non-convex bilevel problem can be relaxed using a smooth approximation, see problem (2).

The non-convex bilevel problem can then be solved using a stochastic method, see problem (3).

Towards this end, a CL framework is described for wireless systems, which incrementally adapts the DNN models by using data from the new batches as well as a limited but carefully selected subset of data from the previous batches; see FIG. 2. Compared with the existing heuristic boundary-free CL algorithms, the approaches described herein is based upon a clearly defined optimization formulation that is tailored for the wireless resource allocation problem. For example, the CL methods described herein may be based on a bilevel optimization which selects a small set of important data samples into the working memory according to certain data-sample fairness criterion. The lower level of constrained non-convex bilevel problem may be further relaxed using a smooth approximation, and propose and analyze practical (stochastic) algorithms for model training. Moreover, the effectiveness of the described framework is demonstrated by way of simulation by applying the techniques to two DNN based models (one for power control and the other for beamforming). The CL approach described herein is further tested using both synthetic and ray-tracing based data.

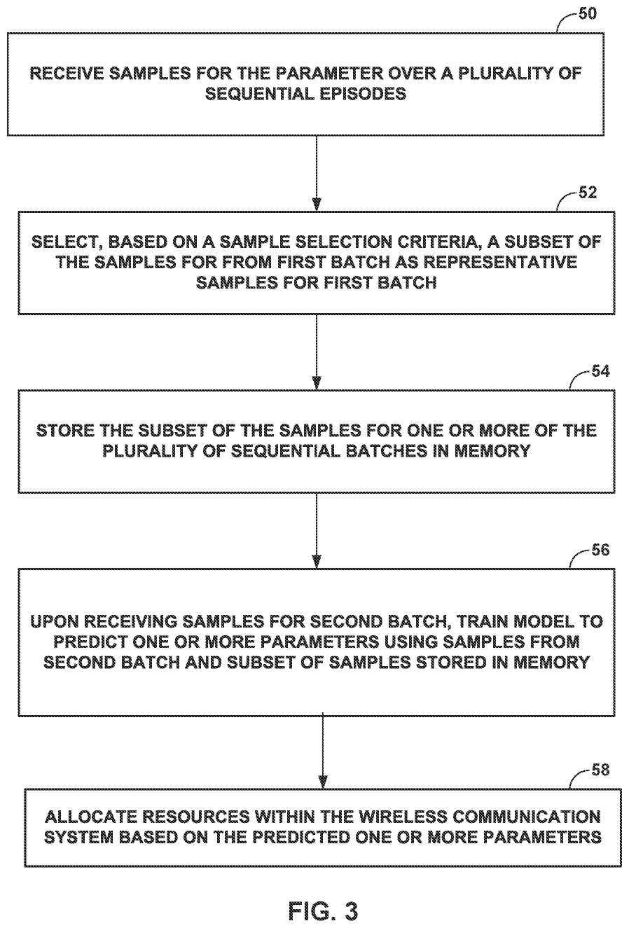

FIG. 3 is a flowchart illustrating example operation of a wireless system. For purposes of example, FIG. 3 is described with respect to one or more processors, examples of which include processor 14A or 14B (FIG. 1A), processor 26 (FIG. 1B), or processor 28 (FIG. 2). For instance, the one or more processors may be configured to operate within a control system for a wireless communication network or within an individual base station or mobile device.

In general, the one or more processors receive samples of a wireless communication system over a plurality of sequential batches, wherein each of the batch represents a different, non-overlapping period of times (50).

For each of the batch, the one or more processors may select, based on a sample selection criteria, a subset of samples from a first batch (e.g., previous batch) of the plurality of batches as representative samples for the first batch (52). For example, sample selection criteria may be based on a system performance metric computed for each of the samples. As one example, the sample selection criteria comprises samples in first batch that have relatively low system performance compared to other samples in the first batch.

For instance, the one or more processors may determine performance metric of the wireless communication system at each of the samples (e.g., snapshots) in the first batch. The performance metric may be throughput rate, bit error rate, etc. The one or more processors may determine the samples in the first batch for which the performance metric was the lower than the performance metric for the other samples. As an example, the one or more processors may determine the N samples in the first batch having the lowest performance metric.

As another example, the sample selection criteria may be based on a bilevel optimization formulation that selects the subset of samples for storage within the memory. For instance, the bilevel optimization formulation may be an iterative process used to determine the subset of samples. In some examples, the bilevel optimization may utilize performance metrics, such as which samples have low system performance (e.g., performance metric is low), as part of the optimization.

The one or more processors may store the subset of the samples for one or more of the plurality of sequential batches in the memory (54). For instance, the subset of samples that the one or more processors selected may be used subsequently for training for future batches.

Upon receiving samples for a second batch (e.g., current batch), the one or more processors may train the model 18A or 18N to predict the one or more parameters using the samples from the second batch and the subset of the samples stored in the memory (56). For example, the one or more processors may generate trained model 18A or 18N using samples from the second batch and the subset of the samples stored in memory, and apply samples from the second batch as inputs to models 18A or 18N. The output may be the one or more parameters of the wireless communication system. In some examples, the one or more parameters may be an estimate of channel state information for a wireless channel of the wireless communication system. Examples of the one or more parameters include power parameters, beamforming parameters, multicasting parameters, multiuser detection, channel estimation parameters, spectrum sensing parameters, or spectrum/channel/antenna allocation parameters.

The one or more processors may be configured to allocate resources within the wireless communication system is based on the predicted one or more parameters (58). As one example, to allocate resources, the one or more processors may be configured to control an allocation of power to a plurality of base stations of the wireless communication system for a given geographic region based on the predicted one or more parameters. As another example, to allocate resources, the one or more processors may be configured to control beamforming for a plurality of antennas of the wireless communication system based on the predicted one or more parameters.

In this way, this disclosure describes example implementations of continual learning system with memory selected based on system performance. As describes, data samples of one or more parameters of a wireless system are sampled over time. The time sequence sampling stream is continuously processed over a plurality of separate batches. In some examples, at the beginning of each batch, the system trains model 18A or 18N using data samples from the current batch and a memory set of representative samples from the previous batches of the time sequence. Moreover, the one or more processors treat the current batch samples and the representative samples from memory M as candidate sample pool for the next batch.

At the end of each batch, the one or more processors select representative samples from the candidate sample pool to update memory M with a sample set for training model M at the beginning of the next batch.

During the sample selection for memory M, the one or more processors directly use features of the learning problem at hand (i.e., actual wireless system performance) to enable and apply a memory selection mechanism.

As one example, selection criteria applied by the one or more processors may be based on sample fairness. That is, in on example selection mechanism, the one or more processors use a “sample fairness” criteria to select the most representative data samples into the working memory. When selecting from a candidate sample pool (i.e., those samples that are in the memory+the newly arrived samples), the one or more processors use the following procedure:
a. Compute each sample's system performance (such as throughput) under the current learning model. The system level performance can be the throughput, bit error rates, etc.
b. Given relatively high weights for each data sample with relatively low system performance (evaluated by the one or more processors for each one at step a.), compared with other samples from the candidate pool. In other words, the one or more processors may be configured to assign high weights for the samples with low system performance, where in this configuration “high” and “low” are all relative to the samples in the pool (current sample+those already in the memory).
c. For each batch, since the “optimal” neural network model depends on the current training samples and their weights that it is trained, the one or more processors may be configured to perform step a.) and b.) iteratively until determine a “best” neural network model for model 18, and the “best” set of sample weights. In some examples, the selection process is done by solving the bi-level optimization problem (9).
d. Once the bi-level problem in c.) is solved, the one or more processors may update memory set M using the selected data samples (i.e., those data samples that have relatively large weights compared with other samples). In this way, model M is continuously trained and memory M is updated based on the identified sample weights for the samples.

Other selection criteria include:
a. Sample fairness criteria—select low system performance samples, the system performance includes throughput, bit error rates, etc.
b. Time fairness criteria—select same amount of samples from each batch
c. Randomness criteria—random select samples

Additional example applications implement by the one or more processors when allocating resources within the wireless communication system in response to the predicted current value for the parameter(s) include:

a. Power control

b. Beamforming

c. Multicasting

d. Multiuser Detection

e. Channel estimation

f. Spectrum sensing

g. Spectrum/channel/antenna allocation

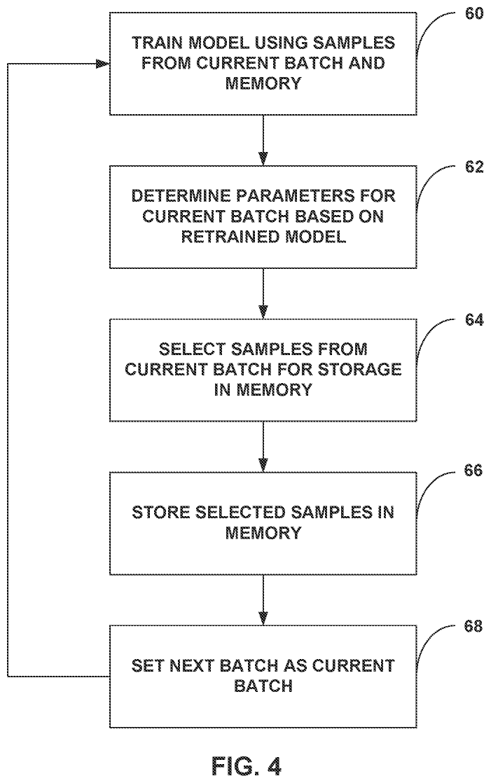

FIG. 4 is a flowchart illustrating another example operation of the wireless communication system according to the techniques described herein. In the example of FIG. 4, one or more processors may train a neural network to generate model 18A or 18N using samples from current batch and memory (60). For instance, at an initial time in the current batch, the one or more processors may receive samples from the current batch. The one or more processors may utilize the samples from the current batch and samples from the memory, where the samples from the memory are samples from one or more previous batches. The one or more processors may utilize supervised or unsupervised training to train a neural network to generate trained models 18A or 18N. As one example, the current batch may be one hour, and the initial time may be ten minutes. The samples may include information about the characteristics (e.g., environment) of the wireless communication system, and may be a snapshot of the wireless communication system (e.g., less than one minute or one second of environment information of the wireless communication system).

The one or more processors may determine parameters for current batch based on retrained model (e.g., models 18A or 18N) (62). For instance, the one or more processors may determine an estimate of channel state information for a wireless channel of the wireless communication system. Examples of the one or more parameters include power parameters, beamforming parameters, multicasting parameters, multiuser detection, channel estimation parameters, spectrum sensing parameters, or spectrum/channel/antenna allocation parameters.

The one or more processors may select samples from the current batch for storage in memory (64). For instance, the one or more processors may select, based on a sample selection criteria, a subset of the samples from current batch of the plurality of time batches as representative samples for the current batch. The sample selection criteria may be based on a system performance metric computed for each of the samples. For example, the sample selection criteria may be samples in current batch that have relatively low system performance compared to other samples in the current batch. As another example, the sample selection criteria may be based on a bilevel optimization formulation that selects the subset of samples for storage within the memory. In some examples, the bilevel optimization formulation may also use performance metric, such as which samples having relative low system performance, for selecting the subset of samples for storage within memory.

In some examples, the one or more processors may use the models 18A or 18N for the remainder of the current batch, but the example techniques are not so limited. In some examples, the one or more processors may continuously retrain the neural networks to generate models 18A or 18N. For instance, throughout the current batch, the one or more processors may determine samples for storage in memory (e.g., using performance metric), and retrain the neural network to generate trained models 18A or 18N.

The one or more processors may store the selected samples in memory (66). For instance, the selected samples may then be used by a next batch for retraining the neural network. For example, the one or more processors may set the next batch as the current batch (68), and repeat the example operations of FIG. 4.

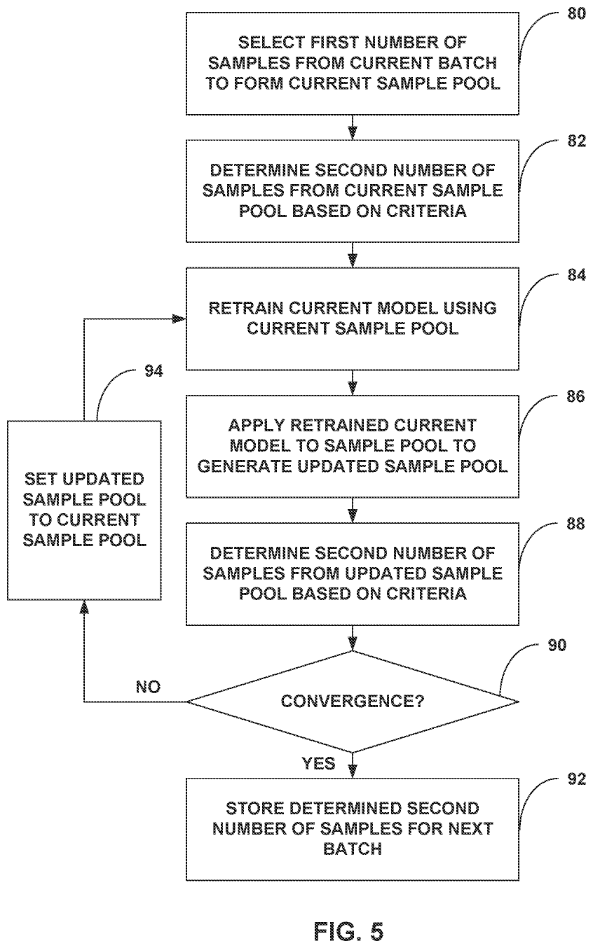

FIG. 5 is a flowchart illustrating an example of bilevel optimization for determination of samples to be stored. For instance, as described in more detail, the bilevel optimization may be an iterative process of iterative retraining of models and determining samples in accordance with example criteria until there is convergence.

For example, at the end of the current batch (e.g., first time batch), the one or more processors may determine samples that should be stored for training in a subsequent batch (e.g., second time batch). For example, the one or more processors may select a first number of samples from current batch (e.g., first time batch) to form a current sample pool (80). In some examples, the first number of samples may be all or some of the samples of the current batch. In some examples, the first number of samples may be the N samples having the low performance in the current sample. Other techniques to determine the first number of samples that form a current sample pool are possible.

The one or more processors may determine a second number of samples from current sample pool based on criteria (82). As one example, if there are N samples in the current sample pool, the one or more processors may select M samples, where M (the second number of samples) is less than N (the first number of samples). As one example, the one or more processors may use a performance metric as the criteria. For instance, the one or more processors may evaluate the M samples having low performance from among the N samples that form the current sample pool.

The one or more processors may retrain a model of the current batch (e.g., first time batch) using the current sample pool (84). For instance, the one or more processors may use the current sample pool to update model 18A or 18N. In some examples, the updated models 18A and 18N may not be used to determine parameters for the current batch. Rather, the updated models 18A and 18N may be temporary models that are used as part of the bilevel optimization.

The one or more processors may apply the retrained model to the sample pool to generate an updated sample pool (86). The one or more processors may determine second number of samples from updated sample pool based on criteria (88).

For example, in a first iteration, the one or more processors determined M number of samples from the current sample pool, such as based on which samples had low performance. In a second iteration, the one or more processors may determine M number of samples from the updated current sample pool, such as based on which samples had low performance.

The one or more processors may determine whether there is convergence (90). For example, the one or more processors may determine whether the determined samples from the updated current sample pool (e.g., second iteration) are the same as samples determined in a previous iteration (e.g., first iteration).

If the determined samples are not the same as samples determined in a previous iteration (NO of 90), the one or more processors may set the updated sample pool to the current sample pool, and iterate through the operations. That is, the one or more processors may repeat retraining, applying, determining, and determining whether the determined samples are same as samples determined in the previous iteration until the determined samples are same as samples determined in the previous iteration. If the determined samples are the same as samples determined in a previous iteration (YES of 90), the one or more processors may store the determined second number of samples for next batch (92). That is, the subset of samples that the one or more processor selects for storage in memory may be the determined samples, where the determine samples are the samples that led to convergence.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

1. A wireless communication system comprising:
memory configured to store a model for predicting one or more parameters of the wireless communication system; and
one or more hardware-based processors configured to:
receive samples of the wireless communication system over a plurality of sequential batches, wherein each of the batches represents a different, non-overlapping period of time;
for each of the batches:
select, based on a sample selection criteria, a subset of the samples from a first batch of the plurality of batches as representative samples for the first batch, wherein the sample selection criteria is based on a system performance metric computed for each of the samples;
store the subset of the samples for one or more of the plurality of sequential batches in the memory; and
upon receiving samples for a second batch, train the model to predict the one or more parameters using the samples from the second batch and the subset of the samples stored in the memory.

2. The system of claim 1, wherein the sample selection criteria comprises samples in first batch that have relatively low system performance compared to other samples in the first batch.

3. The system of claim 1, wherein the sample selection criteria is based on a bilevel optimization formulation that selects the subset of samples for storage within the memory.

4. The system of claim 1, wherein to select the subset of samples, the one or more hardware-processors are configured to:
retrain a model of the first batch using a sample pool of the first batch;
apply the retrained model to the sample pool to generate updated sample pool;
determine samples from updated sample pool based on the selection criteria;
determine whether the determined samples are same as samples determined in a previous iteration; and
repeat, as another iteration, retraining, applying, determining, and determining whether the determined samples are same as samples determined in the previous iteration until the determined samples are same as samples determined in the previous iteration,
wherein the subset of samples comprise the determined samples.

5. The system of claim 1, wherein the one or more parameters comprise an estimate of channel state information for a wireless channel of the wireless communication system.

6. The system of claim 1, wherein the one or more hardware-processors are configured to allocate resources within the wireless communication system is based on the predicted one or more parameters.

7. The system of claim 6, wherein to allocate resources, the one or more hardware-processors are configured to control an allocation of power to a plurality of base stations of the wireless communication system for a given geographic region based on the predicted one or more parameters.

8. The system of claim 6, wherein to allocate resources, the one or more hardware-processors are configured to control beamforming for a plurality of antennas of the wireless communication system based on the predicted one or more parameters.

9. A method for predicting one or more parameters of a wireless communication system:
receiving samples of the wireless communication system over a plurality of sequential batches, wherein each of the batches represents a different, non-overlapping period of time;
for each of the batches:
selecting, based on a sample selection criteria, a subset of the samples from a first batch of the plurality of batches as representative samples for the first batch, wherein the sample selection criteria is based on a system performance metric computed for each of the samples;
storing the subset of the samples for one or more of the plurality of sequential batches in a memory; and
upon receiving samples for a second batch, training the model to predict the one or more parameters using the samples from the second batch and the subset of the data samples stored in the memory.

10. The method of claim 9, wherein the sample selection criteria comprises samples in the first batch that have relatively low system performance compared to other samples in the first batch.

11. The method of claim 9, wherein the sample selection criteria is based on a bilevel optimization formulation that selects the subset of data samples for storage within the memory.

12. The method of claim 9, wherein selecting the subset of samples comprises:
retraining a model for the first batch using a sample pool of the first batch;
applying the retrained model to the sample pool to generate updated sample pool;
determining samples from updated sample pool based on the selection criteria;
determining whether the determined samples are same as samples determined in a previous iteration; and
repeating, as another iteration, retraining, applying, determining, and determining whether the determined samples are same as samples determined in the previous iteration until the determined samples are same as samples determined in the previous iteration,
wherein the subset of samples comprise the determined samples.

13. The method of claim 9, wherein the one or more parameters comprise an estimate of channel state information for a wireless channel of the wireless communication system.

14. The method of claim 9, further comprising allocating resources within the wireless communication system based on the predicted one or more parameters.

15. The method of claim 14, wherein allocating resources comprises controlling beamforming for a plurality of antennas of the wireless communication system based on the predicted one or more parameters.

16. The method of claim 14, wherein allocating resources comprises controlling an allocation of power to a plurality of base stations of the wireless communication system for a given geographic region based on the predicted one or more parameters.

17. A computer-readable storage medium comprising instructions for causing a programmable processor to:
receive samples of a wireless communication system over a plurality of sequential batches, wherein each of the batches represents a different, non-overlapping period of time;
for each of the batches:
select, based on a sample selection criteria, a subset of the samples from a first batch of the plurality of batches as representative samples for the first batch, wherein the sample selection criteria is based on a system performance metric computed for each of the samples;
store the subset of the samples for one or more of the plurality of sequential batches in the memory; and
upon receiving samples for a second batch, train the model to predict the one or more parameters using the samples from the second batch and the subset of the samples stored in the memory.

18. The computer-readable storage medium of claim 17, wherein the sample selection criteria comprises samples in first batch that have relatively low system performance compared to other samples in the first batch.

19. The computer-readable storage medium of claim 17, wherein the sample selection criteria is based on a bilevel optimization formulation that selects the subset of samples for storage within the memory.

20. The computer-readable storage medium of claim 17, wherein the instructions that cause the one or more processors to select the subset of samples comprise instructions that cause the one or more processors to:
retrain a model of the first batch using a sample pool of the first batch;
apply the retrained model to the sample pool to generate updated sample pool;
determine samples from updated sample pool based on the selection criteria;
determine whether the determined samples are same as samples determined in a previous iteration; and
repeat, as another iteration, retraining, applying, determining, and determining whether the determined samples are same as samples determined in the previous iteration until the determined samples are same as samples determined in the previous iteration,
wherein the subset of samples comprise the determined samples.
